(19) United States
(12) Patent Application Publication
(10) Pub. No.: US 2006/0107221 A1
(43) Pub. Date: May 18, 2006

(54) Hierarchical selection box for e-mail addressing

(76) Inventor: Tobias Haug, Heidelberg (DE)

Correspondence Address: KENYON & KENYON LLP, ONE BROADWAY, NEW YORK, NY, 10004, US

(21) Appl. No.: 11/026,020

(22) Filed: Jan. 3, 2005

Related U.S. Application Data
(60) Provisional application No. 60/621,429, filed on Oct. 22, 2004.

(51) Int. Cl. G06F 17/00; G06F 3/00; G06F 7/00; G06F 17/30

(52) U.S. Cl. 715/752; 707/3; 707/7; 715/764

(57) ABSTRACT

The present invention provides a system and method for providing a hierarchical selection box for addressing an e-mail that allows a user to drill down to specific contacts using business organization data. A user may select a category such as employer, department, or specialty area to obtain a display of contacts organized by that category. The system allows a user to schedule appoints in the same way that the user thinks. The user can identify individuals having common characteristics, e.g., being members of the same department, being project managers, and easily select these individuals and request their attendance at a meeting, video conference or telephone conference.

### BACKGROUND

Businesses often rely on electronic communications to convey information. Electronic mail (e-mail) is one form of electronic communication that is often used. E-mail messages may be sent from one individual to another to convey information. One such message is an appointment request that may be sent to individuals to request their participation in a meeting, telephone conference or video conference. A user may send an appointment request to various individuals providing a date and time of a meeting. Upon receipt of the appointment request, the invitees may accept or decline the request. This causes a response to be sent back to the user. The user will then know who is able to attend and can schedule the meeting accordingly.

When an appointment request is being created, it may be difficult for a user to identify which individuals should be invited. Although a company is likely to maintain information about contacts, such as e-mail addresses, employer, business addresses, department and telephone numbers, this information is often stored in another file or another system. For example, businesses may maintain contact information in a backend database for use by other business services.

Attempting to locate this information to determine who should be invited to participate in a meeting may be a cumbersome process. For example, if a user wishes to schedule a meeting to discuss a particular scientific matter, an individual may have to attempt to obtain an organization chart of a department or of another company to identify individuals who work in areas related to this matter who would be interested in attending the meeting. The user must then review the chart and select the invitees manually. Benefits would be obtained from an automated process that would allow a user to access this organizational information while setting up the appointment.

### BRIEF DESCRIPTION OF THE DRAWINGS

FIG. 1 depicts a hierarchical selection box process according to one embodiment of the invention.

FIG. 2 shows an appointment scheduling process according to one embodiment of the invention.

FIG. 3 illustrates a hierarchical selection box search display according to one embodiment of the invention.

FIG. 4 illustrates an e-mail engine according to one embodiment of the invention.

### DETAILED DESCRIPTION

The present invention provides a system and method for providing a hierarchical selection box for addressing an e-mail that allows a user to drill down to specific contacts using business organization data. A user may select a category such as employer, department, or specialty area to obtain a display of contacts organized by that category. The system allows a user to schedule appoints in the same way that the user thinks. The user can identify individuals having common characteristics, e.g., being members of the same department, being project managers, and easily select these individuals and request their attendance at a meeting, video conference or telephone conference.

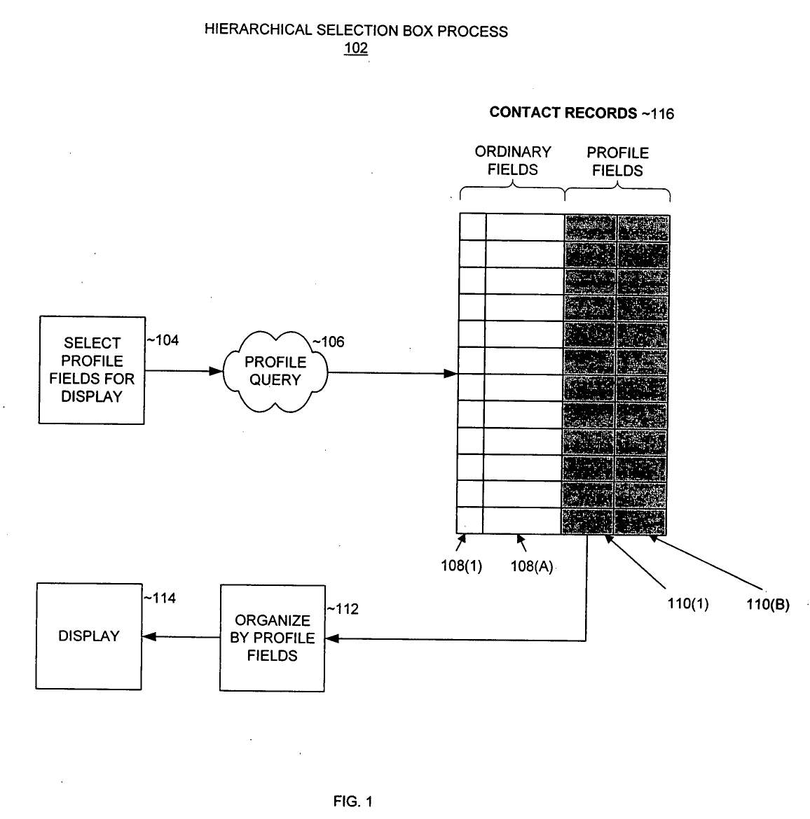

FIG. 1 depicts a hierarchical selection box process 102 according to one embodiment of the invention. The hierarchical selection box process 102 provides a drill-down approach for selecting contacts to include on an electronic communication. The hierarchical selection box process 102 may operate within any groupware application, such as a Microsoft Outlook e-mail program, SMS text message program, an MMS text message program, or any other e-mail program.

Contact records 116 stores information that describes individuals or businesses that may be included as recipients of e-mail messages or appointment requests that are created using the e-mail application. The contact information may be stored as an array of fields 108(1)-108(A), some of which are profile fields 110(1)-110(B). A field 108 may store a contact name, e-mail address or any other contact information such as telephone number or facsimile number. Profile fields 110(1)-110(B) characterize the nature of a contact's involvement with the organization or individual maintaining contacts records 116. For example, profile fields 110(1)-110(B) that may be used to characterize a contact's involvement with a business may include employer, department, title, practice specialty, product awareness, manager, and any other information that may be useful to categorize contacts for purposes of scheduling appointments. Table 1 provides a simple example of contact records and associated profile fields.

TABLE 1

| Ordinary Fields | | | Profile Fields | | | | |
|---|---|---|---|---|---|---|---|
| Contact | First | Last | | | | Practice | Product |
| No. | Name | Name | Employer | Title | Department | Area | Manager |
| 1 | Joe | Smith | XYZ, Inc. | Manager | Engineering | Software | N/A |
| 2 | John | Doe | XYZ, Inc. | Engineer | Engineering | Software | Joe Smith |
| 3 | Jane | Doe | ABC, Inc. | Manager | Engineering | Electronics | N/A |

In step 104, a user selects from profile fields 110(1)-110(B) for display using the hierarchical selection box. In the example above, a user may select any of profile fields including employer, title, department, specialist area, or product manager.

In step 106, a profile query is sent to contact records 116 to obtain a set of contacts organized in a hierarchy by profile fields. The profile query may comprise one or more selected profile fields so that it can be used to group contact records 116 according to the content within the selected profile fields. Contact records 116 may be stored locally within a contacts folder of the e-mail application. In an alternate embodiment of the invention, contact records 116 is an external file in, for example, HyperText Markup Language (HTML) format that may be stored on the World Wide Web or on a server. The e-mail application may access contact records 116 by a link provided in the e-mail application that allows access to this external file.

In step 112, a search set that is organized by the selected profile fields is retrieved from contact records 116. Using the exemplary contact records 116, if a user selects the profile field practice area, the search set that is retrieved will list the contacts by specialty as illustrated below.

Electronics

| | | | | | | | |
|---|---|---|---|---|---|---|---|
| 1 | Jane | Doe | ABC, | Manager | Engineering | Product | 20001 |
| | | | Inc. | | | Manager: | |
| | | | | | | N/A | |

Software

| | | | | | | | |
|---|---|---|---|---|---|---|---|
| 1 | Joe | Smith | XYZ, | Manager | Engineering | Product | 10004 |
| | | | Inc. | | | Manager: | |
| | | | | | | N/A | |
| 2 | John | Doe | XYZ, | Engineer | Engineering | Product | 10004 |
| | | | Inc. | | | Manager: | |
| | | | | | | Joe | |
| | | | | | | Smith | |

A tiered search set may be retrieved. For example, a user may select to organize contacts first by employer and then by practice area. The resulting search set is organized by the various employers and practice areas as selected by the user.

In step 114, the search set is displayed to a user organized by the hierarchy selected by the user. Information may be displayed using a graphical user interface or any other output provided to user by, for example, a personal computer, cellular telephone, personal data assistant or any other electronic device.

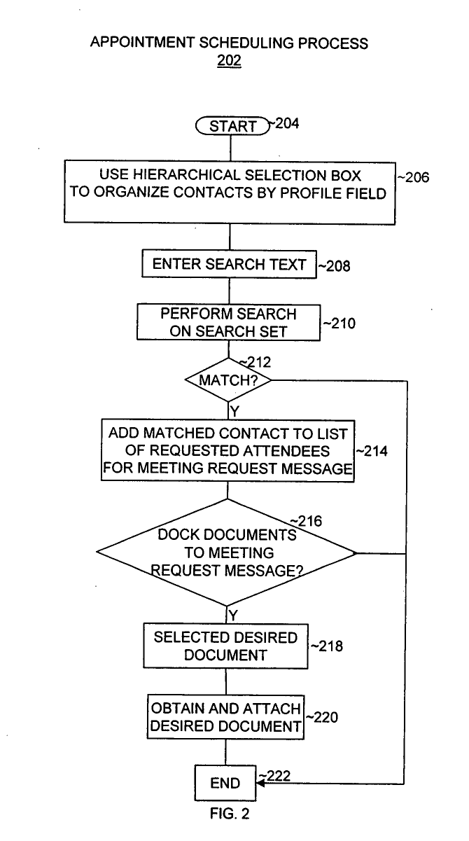

FIG. 2 shows an appointment scheduling process according to one embodiment of the invention. An appointment may be scheduled using, for example, a feature in any groupware or electronic messaging application that allows for scheduling of appointments. A user may select to send a message requesting an appointment for a meeting, video conference or telephone conference.

In step 206, a hierarchical selection box is used to organize contacts by profile field so that an e-mail may be addressed using contacts selected from the organized set of contacts. A set of data that is organized by selected profile fields is retrieved. A user may select to organize contacts by multiple profile fields. A tiered search set may be retrieved that is organized according to the tiered approach selected by the user. A user may also select to organize data by a single profile field.

In step 208, search text is entered. A user may have the added option of entering text to be used to search the organized set of contact data that was retrieved. For example, a user may select to search for everyone employed by XYZ, Inc. by entering the text XYZ, Inc. In this example, the data set organized by profile field, i.e., employer field, will be searched for XYZ, Inc. This search set may be sent in another query to an external file to determine whether a match is located.

In step 210, a search is performed on the search set. A search is performed on the data set organized by profile field using the text that was entered. For example, if the text XYZ, Inc. is entered for a search on the category employer, the employer field will be searched for the text XYZ, Inc.

In step 212, a determination is made of whether a match was located. A match is detected if the text that was searched for is located in the search set. For example, if a search is performed for everyone employed by XYZ, Inc., Joe Smith and John Doe would match the search criteria and would be retrieved. If no match is found, processing is complete as is reflected by step 222.

In step 214, the user may add a matched contact to the list of requested attendees for the meeting request message. If one or more matches are located, these matched contacts are provided to the user, for example, via a display. The user may select one or more matched contacts to add to the meeting request message that is being created.

In step 216, the user may select to dock documents to the meeting request message. If a user does not select to dock documents, processing is complete, as is reflected by step 322.

If a user selects to dock documents, in step 218, a user may search for and retrieve documents using the e-mail application. A user may select from the retrieved documents one or more documents to attach to the meeting request message.

In step 220, the selected document is obtained and attached to the meeting request message. Electronic files, such as those stored in accordance with electronic formats specified by Microsoft, e.g., Word, Excel, and Powerpoint, Adobe or any other electronic format may be attached to the meeting request message. After the document is attached, processing is complete, as is reflected by step 222.

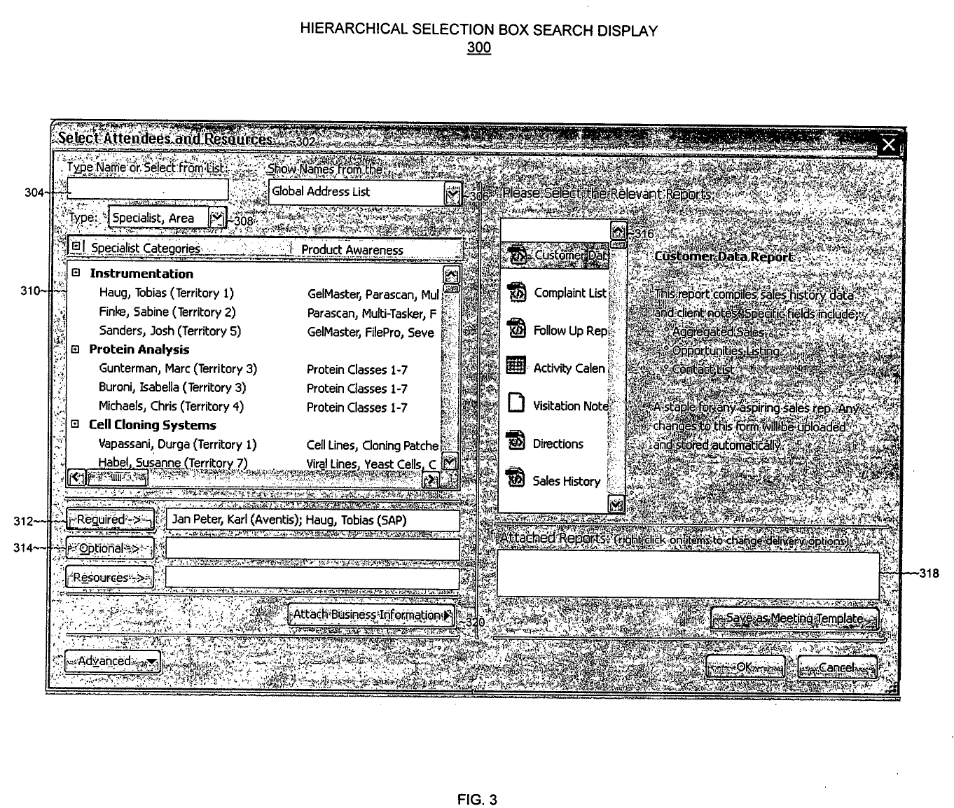

FIG. 3 illustrates a hierarchical selection box search display 300 according to one embodiment of the invention. Hierarchical selection box search display 300 may comprise a select attendees and resources view 302 that queries a user to provide selections to generate a meeting request message that will be sent to request attendance at a meeting. Select attendees and resources view 302 may query a user for selection of attendees of a meeting and selection of reports to attach to a meeting request message.

Select attendees and resources view 302 may include a type name or select from list control 304, show names control 306 or type control 308. Type name or select from list control 304 may be used to enter search text by either typing the text or selecting from a list of text. If a user chooses to select from a list, the user may obtain a list of profile fields 110(1)-110(B) using type control 308 that can be used to organize contacts. Show names control 306 may provide various lists that can be searched from, such as a global address list.

Select attendees and resources view 302 may also include a contacts display window 310 that allows a user to view results from a search performed.

A user may select from contacts listed and chose to add these contacts to the appointment request message. The appointment request functionality may be provided by appointment request features of e-mail programs, such as those available with Microsoft Outlook or any other electronic messaging system. The user may select to add these contacts using required control 312 or an optional control 314. Required control 312 may be used to indicate that an attendee is a required participant of the meeting. Optional control 314 may be used to indicate that an attendee is an optional participant. The e-mail program can then automatically schedule the meeting if all required participants respond to the meeting request message indicating that they can attend. In an alternate embodiment of the invention, a single attendee control is included that, when selected, does not indicate whether an attendee is required or optional. In this embodiment, the meeting may not be automatically scheduled or may be tentatively scheduled. Attach business information control 320 may also be included to allow a user to attach expanded identification information for a requested meeting participant displayed in the form of a business card which may include the logo of the requested participant's company.

Additionally, select attendees and resources view 302 may include customer data report display 316 and attached reports display 318. Customer data report display 316 may be used to display titles of reports that can be attached to a meeting message request. Additional controls may be included so that a search may be performed of titles of documents to display using customer data report display 316. According to one embodiment of the invention, the title of any type of document may be displayed using customer data report display 316. A feature may be included that displays a short description of a document when the document is highlighted. A user may select a document by clicking on the title of the document on customer data report display 316. The titles of any selected documents may then be displayed using attached reports display 318. A feature may included to allow a user to right click on items to change delivery options.

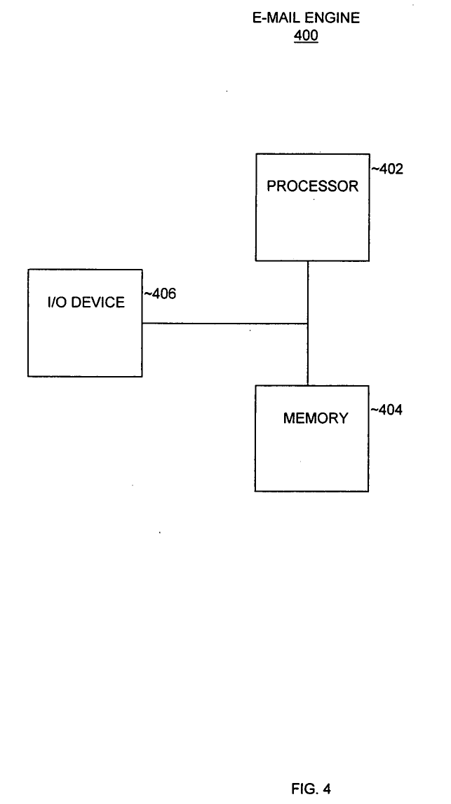

FIG. 4 illustrates an e-mail engine according to one embodiment of the invention. E-mail engine 400 includes processor 402, memory 404, and I/O device 406. Processor 402 is connected to memory 404. Processor 402 is also connected to I/O device 406. These connections are direct or via other internal electronic circuitry or components.

Processor 402 may be any programmable processor that executes instructions residing in memory 404 to receive and send data via I/O device 406 including any programmable microprocessor or combination of microprocessors or processors that can operate on digital data, which may be special or general purpose processors coupled to receive data and instructions from, and to transmit data and instructions to, a machine-readable medium. According to one embodiment of the present invention processor 402 is an Intel microprocessor.

Memory 404 may be any machine-readable medium that stores data that is processed by processor 402 including any computer program product, apparatus and/or device (e.g., a random access memory (RAM), read only memory (ROM), magnetic disc, optical disc, programmable logic device (PLD), tape, or any combination of these devices). This may include external machine-readable mediums that are connected to processor 402 via I/O device 406. I/O device 406 may be any coupling that can be used to receive and/or send digital data to and from an external device.

Various implementations of the systems and techniques described here can be realized in any processing systems and/or digital electronic circuitry, integrated circuitry, specially designed ASICs (application specific integrated circuits), computer hardware, firmware, software, and/or combinations thereof.

A number of embodiments of the invention have been described. Nevertheless, it will be understood that various modifications may be made without departing from the spirit and scope of the invention.

What is claimed is:

1. A groupware addressing method comprising:
according to a selected profile field, organizing contact records according to contents of said selected profile field;
displaying the resulting set of contact records organized according to said contents of said selected profile field; and
responsive to user input, adding selected contacts to a communication.

2. The groupware addressing method of claim 1 further comprising:
upon receipt of a selection, attaching a selected document to the communication.

3. The groupware addressing method of claim 1, further comprising:
presenting to a user an option to search documents to attach to the communication.

4. The groupware addressing method of claim 1, wherein said selected profile field is an employer, a title, a department, a practice area, product awareness or a product manager.

5. The groupware addressing method of claim 1, wherein said selected profile field is a practice area.

6. The groupware addressing method of claim 1, wherein said communication is an appointment request.

7. The groupware addressing method of claim 6, wherein said selected contacts are added to the communication as required participants or as optional participants.

8. The groupware addressing method of claim 1, wherein said contact records are organized in a tiered manner according to the contents of the selected profile field and second contents of a second selected profile field.

9. The groupware addressing method of claim 1, wherein the selected profile field characterizes an individual's involvement with an organization.

10. In a groupware application, a graphical user interface for displaying a hierarchical selection box comprising:
a first spatial area of display to display a set of contact records organized according to contents of a selected profile field; and
a control that when activated adds a selected contact to a communication.

11. The graphical user interface of claim 10, further comprising:
a second spatial area of display to display available documents; and
a second control that when activated attaches a selected document to the communication.

12. A computer readable medium storing thereon program instructions that, when executed, cause an executing device to:
according to a selected profile field, organize contact records according to contents of said selected profile field;
display the resulting set of contact records organized according to said contents of said selected profile field; and
responsive to user input, add selected contacts to a communication.

13. The computer readable medium of claim 12 further comprising instructions that cause the executing device to:
attach a selected document to the communication upon receipt of a selection.

14. The computer readable medium of claim 12 further comprising instructions that cause the executing device to:
present to a user an option to search documents to attach to the communication.

15. The computer readable medium of claim 12; wherein said selected profile field is an employer, a title, a department, a practice area or a product manager.

16. The computer readable medium of claim 12, wherein said selected profile field is a practice area.

17. The computer readable medium of claim 12, wherein said communication is an appointment request.

18. The computer readable medium of claim 17, wherein said selected contacts are added to the communication as required participants or as optional participants.

19. The computer readable medium of claim 12, wherein said contact records are organized in a tiered manner according to the contents of the selected profile field and second contents of a second selected profile field.

20. The computer readable medium of claim 12, wherein the selected profile field characterizes an individual's involvement with an organization.
